(19) United States
(12) Patent Application Publication
(10) Pub. No.: US 2012/0267547 A1
(43) Pub. Date: Oct. 25, 2012

(54) Method for generating an ion current in a hair shaping or care appliance

(75) Inventor: Klaus Hafemann, Moers (DE)

(73) Assignee: WIK FAR EAST LTD., North Point (HK)

(21) Appl. No.: 13/123,946

(22) PCT Filed: Oct. 14, 2008
(86) PCT No.: PCT/EP2008/063776

§ 371 Date: Feb. 7, 2012

(51) Int. Cl. H01T 23/00

(52) U.S. Cl. 250/424

(57) ABSTRACT

A method is used to generate an ion current in a hair shaping or care appliance which comprises an ionization apparatus (7) having at least one high voltage generator (4) and at least one electrode connected to the high voltage generator (4). For this purpose, during the ionization process, an ion current having a first polarity of the ions thereof is provided for supplying ions to the hair to be cared for or shaped, and said ion current is intermittently interrupted, and during the interrupted time an ion current comprising ions having a second polarity which is opposite of the first polarity is generated.

### CROSS REFERENCE APPLICATIONS This application is a National Stage entry of PCT/EP2008/0063776 filed Oct. 14, 2008.

### BACKGROUND

The disclosure relates to a method for generating an ionic current in a hair shaping or hair care appliance comprising an ionization apparatus with at least one high-voltage generator and at least one electrode connected to the high-voltage generator.

Examples of hair care appliances with ionic generators include hair dryers, air curlers, straighteners, crimpers or the like. Such appliances can have an ionization apparatus to support the shaping or caring process. An ionic current can be supplied during the caring or shaping process to the hair with such an ionization apparatus. The main purpose of the ionization is to reduce or neutralize the charge on the hair typically electrostatically charged by combing. Such an ionization apparatus comprises a high-voltage generator as well as one or more electrodes connected to it. The electrodes are designed such that they are suitable for generating an ionic current. Either an ionic current with negatively charged particles (anions) or positively charged particles (cations) is generated depending on the polarity of the high voltage supplied to such an electrode. The ionization apparatuses in previously known hair shaping and/or hair care appliances can be operated with a single polarity. Since experience has shown that hair typically has a positive electrostatic charge, the ionization apparatuses are designed to generate an anionic current. Hair driers are also known that have two ionization apparatuses to be able to generate an ionic current of positively or negatively charged particles as a function of the actual polarity of the electrostatic charge of the hair to be cared for and/or shaped. The prior art also discloses such hair shaping appliances with two ionization apparatuses operated simultaneously with different polarities. As a result, an adjustment of the concentration of ions and of the mixture of anions and cations in the ionic current should be possible. Such a hair shaping appliance is described in WO 03/101242 A2.

The electrodes used for the generation of ionic current are typically located inside the air exit opening. In appliances that comprise a blower for generating an air current directed onto the hair to be cared for or shaped, as with hair driers, the air current serves as a transport medium for transporting the generated ions onto the hair. Appliances are also known with which the hair is formed or cared for without an air current, for example, in straighteners or crimpers. In these appliances the electrodes are located in an electrode frame from which the electrode-emitting tips do not project for technical safety reasons. As a result, improper contacts of the electrodes by a person using such an appliance should be avoided. With hair care appliances with an air current this requirement is already met in that the ionizing electrode is arranged inside the air exit opening, which is typically covered by an air outlet grid. In the case of hair shaping or hair care appliances that do not have an air current transporting the generated ions, the supply of ions to the hair is less effective in spite of the same design of the ionizing apparatus as regards its performance.

The foregoing example of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

Starting from this discussed state of the art, the disclosure therefore has the problem of further developing a hair shaping or hair care appliance in such a manner that an ion supply to the hair to be cared for or to be shaped is improved, in particular in hair care appliances that do not have a blower generating an air current.

In the present disclosure, during the ionization procedure for supplying ions to the hair to be cared for an ionic current with a first polarity of its ions takes place, and this ionic current is intermittently interrupted and during the interruption an ionic current is generated with ions with a second polarity opposite to the first polarity.

In this method, a generation of ions takes place in a first polarity so that, for example, negatively charged particles and thus anions are supplied to the hair to be cared for and/or shaped. This ionic current and its generation are periodically interrupted. During the interruption an ionic current with ions of a second polarity, for example, cations, is generated. The generation of the ionic current with ions of the other, opposite polarity does not primarily serve the purpose in this method to supply an ionic current with a second polarity to the hair to be cared for or shaped, but rather serves the purpose of neutralizing the rather close environment of a housing part relative to the tip of the ionizing electrode, for example, the electrode frame, which tip emits the electrodes. For this reason it is sufficient if the ionic current with the second polarity is generated only for a brief time. Therefore, this method is typically operated in such a manner that the interruptions of the ionic current with the ions with the first polarity can not be detected or recognized by a user by interposing a brief ionic current with ions with the second polarity. The period of the ionic current for generating ions with the first polarity is typically about four times longer than the time provided for the generation of the ionic current with the ions with the second polarity. An unexpected development of this method is that the effectiveness of the ionic current with the ions with the first polarity on the hair to be cared for can be considerably increased by periodically neutralizing the housing sections, for example, the electrode frame, surrounding the ionization electrode in the area of its tip emitting electrons. Thus, an effective ionic current can be supplied to the hair for the entire time of the hair treatment even in hair care appliances that have no air current supplied to the hair to be cared for. It is also not required in order to achieve the desired neutralization of the housing areas or frame areas enclosing the electrode tip that the ionic current with the ions with the second polarity is generated in the same amount as the ionic current with the ions with the first polarity.

The interruption of the ionic current with the ions with the first polarity preferably takes place in a given cycle. This cycle can be changed, if desired, as a function of the particular situation of the using of the hair care appliance.

A preferred embodiment provides generating the ionic current with the ions with the second polarity, that is, for example, cations, by the same electrodes with which the ions of the ionic current with the first polarity are also generated. According to an exemplary embodiment the polarity of the high-voltage generator is reversed from the first polarity to the second polarity for this purpose. It is also possible to provide two high-voltage generators, whereby the one high-voltage generator makes high voltage available in the one polarity and the other high-voltage generator makes it available in the other polarity. The two high-voltage generators are alternately placed in electrically conductive connections with the ionizing electrode or ionizing electrodes according to which polarity are to be generated. It is also possible to provide two ionization units that are independent of one another, whereby the one ionization unit is provided for generating the ionic current with ions with the first polarity and the second ionization apparatus is provided for generating the ionic current or ion impact with the second polarity.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a schematic view of a ionization electrode, received in an electrode frame, of an ionization apparatus of a hair shaping appliance immediately after the starting up of the ionization apparatus.

FIG. 2 is the view of FIG. 1 with the ions generated by the ionization electrode after a certain time span of the operation of the ionization apparatus.

FIG. 3 is the arrangement of FIG. 2 after the generation of ions with opposite polarity.

FIG. 4a, 4b are a diagrams representing the course in time of periods for the generation of ions of the one polarity and of the other polarity with the ionization apparatus of FIGS. 1 to 3 (FIG. 4a), and a schematic representation of the intensity of the ionic current being adjusted from an operation of the ionization apparatus according to FIG. 4a (FIG. 4b).

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION OF THE DRAWINGS

A hair shaping appliance, for example a straightener for smoothing hair (not shown in detail) has an electrode frame 2 in its housing 1 in the area adjacent to its hair shaping plates. An ionization electrode 3 is arranged in electrode frame 2. Ionization electrode 3 is electrically connected to a high-voltage generator 4. High-voltage generator 4 serves to load electrode 3 with high voltage, for example, 5 kV. Ionization electrode 3 is designed in the disclosed embodiment as a needle electrode. Upon a loading of ionization electrode with high voltage generated by high-voltage generator 4, charged particles, for example, electrons, are emitted from the tip 5 of electrode 3, ionized by the ambient air. This produces an ionic current directed toward the hair to be cared for and/or shaped. High-voltage generator 4 is connected to a voltage source in a manner not shown in detail. High-voltage generator 4 is controlled by a microprocessor 6. The hair shaping appliance also has a touch switch with which an operation of the ionization apparatus 7 having a high-voltage generator 4, microprocessor 6 and ionization electrode 3 can be turned on and off.

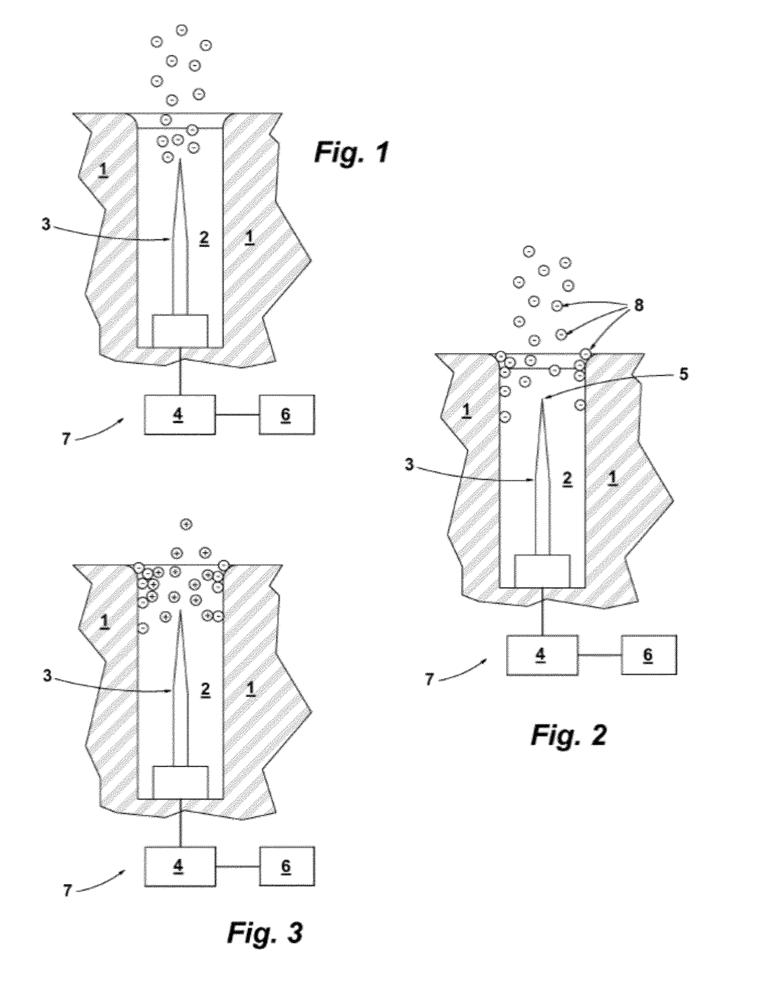

In the depicted embodiment ionization apparatus 7 is designed so that an ionic current with anions is generated by ionization electrode 3. FIG. 1 schematically shows the operation of ionization apparatus 7 immediately after it is turned on. The ionization current being produced is demonstrated by schematically shown anions. Tip 5 of electrode 3 is located, inside electrode frame 2 set back from the mouth of this frame so that a touching of the tip by a user is avoided for safety reasons.

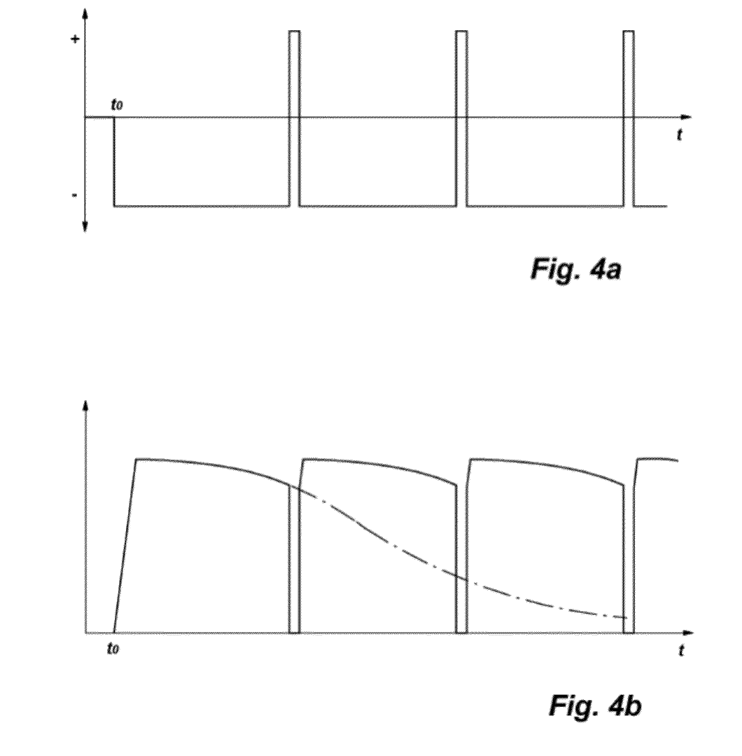

During an operation of ionization apparatus 7 more and more anions 8 are deposited in the mouth area of electrode frame 2, as can be seen in FIG. 2. As the depositing of anions in the mouth area of electrode frame 2 increases, the ionic current directed to the hair to be shaped is weakened and is therefore less effective. During the operation of ionization apparatus 7 an ionic current is briefly interrupted in intervals of time—therefore intermittently—during the generation of this ionic current, which contains the previously described anions, to generate an ionic current or, on account of its briefness, to generate an ion impact with ions with opposite polarity and therefore with cations in the present exemplary embodiment. To this end the polarity of high-voltage generator 4 is reversed. The control of high-voltage generator 4 in this regard is assumed by microprocessor 6. During the course of such a cation impact the anions accumulated in the mouth area of electrode frame 2 are neutralized, as schematically shown in FIG. 3. After the neutralizing of electrode frame 2 the polarity of high-voltage generator 4 is again reversed in order to be able to subsequently generate a current of anions again over a further period. This procedure is repeated as long as ionization apparatus 7 is operated.

FIG. 4a schematically shows a section of the ionic currents developing in the course of an operation of ionization apparatus 7 and changing their polarity. The time is shown on the X axis in FIG. 4a. The diagram makes it clear that in the exemplary embodiment the ionic current to be supplied to the hair is the one with negatively charged particles (anions). The anionic current that is to be supplied to the hair to be shaped is briefly interrupted by cation impacts in order to neutralize electrode frame 2, in uniform time intervals in the exemplary embodiment shown.

FIG. 4b shows the changing intensity of the anionic current in a schematic diagram. In this diagram the time is shown on the X axis and the intensity of the cationic current to be supplied to the hair to be shaped is entered on the Y axis. In this diagram the intensity of the ionic current during an operation of a traditional ionization apparatus, shown in dotted lines, is contrasted with the intensity course when an ionization apparatus is operated as previously described. In an operation of an ionization apparatus in accordance with the state of the art, after a rapid buildup and a first plateau phase, a successive decrease in the intensity of the ionic current supplied to the hair to be cared for is observed. Using the method of the disclosure, the drop of the performance of the ionic current is interrupted again and again and raised again to the initial starting level in the cycle of the cation impacts shown in FIG. 4a for neutralizing electrode frame 2. Therefore, with this method an ionization apparatus can be effectively supplied to the hair to be taken care of or to be shaped even without an air current transporting the ions. In particular, such an ionization apparatus can be operated with lesser power, whereby its mode of operation ensures that a sufficient ionic current is supplied to the hair to be taking care of or to be shaped.

Numerous further embodiments for realizing the claim method result from the description of the invention for a person skilled in the art without having to be explicitly presented. For example, even another electrode, for example, a carbon fiber bundle electrode or stranded electrode can be used as ionization electrode. It is likewise possible to associate several ionization electrodes with an ionization apparatus instead of a single ionization electrode.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true sprit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims

### LIST OF REFERENCE NUMERALS

1 housing
2 electrode frame
3 ionization electrode
4 high-voltage generator
5 tip
6 microprocessor
7 ionization apparatus
8 anion

1-7. (canceled)

8. A method for generating an ionic current in a hair shaping or hair care appliance comprising:
an ionization apparatus with at least one high-voltage generator and at least one electrode connected to the high-voltage generator;
wherein during the ionization procedure for supplying ions to the hair to be cared for an ionic current with a first polarity of its ions takes place; and
intermittently interrupting the ionic current and in the time of the interruption an ionic current is generated with ions with a second polarity opposite to the first polarity.

9. The method of claim 8, wherein the duration of individual interruptions of the ionic current with its ions with the first polarity is multiply shorter than the periods of the emission of ions with the first polarity.

10. The method of claim 8 wherein the ions of the ionic current with the first polarity are anions and that the ions of the ionic current with the second polarity are cations.

11. The method of claim 8 wherein the same electrodes are used for the generation of the ionic current with the ions of the second polarity as are used for the generation of the ionic current with the ions of the first polarity.

12. The method of claim 11 wherein the polarity of the high-voltage generator is reversed to generate the ionic currents with a different polarity.

13. The method of claims 1 wherein the at least one electrode is mounted in an electrode frame and that a free electrode-emitting end of the electrode is located inside the electrode frame.

14. The method of claim 1 wherein the hair shaping or hair care appliance does not have a blower for generating a current of air.
